(19) United States
(12) Patent Application Publication
(10) Pub. No.: US 2022/0258247 A1
(43) Pub. Date: Aug. 18, 2022

(54) Phase Managed Additive Printing System

(71) Applicant: Seurat Technologies, Inc., Wilmington, MA (US)

(72) Inventors: Francis L. Leard, Sudbury, MA (US); James A. DeMuth, Woburn, MA (US); Andrew J. Bayramian, Marblehead, MA (US)

(21) Appl. No.: 17/670,149

(22) Filed: Feb. 11, 2022

Related U.S. Application Data
(60) Provisional application No. 63/148,788, filed on Feb. 12, 2021.

(51) Int. Cl. B22F 12/43; B33Y 10/00; B33Y 30/00; B22F 10/28; B22F 12/45; B23K 26/06; B23K 26/342

(52) U.S. Cl. CPC B22F 12/43; B33Y 10/00; B33Y 30/00; B23K 26/342; B22F 12/45; B23K 26/0608; B22F 10/28

(57) ABSTRACT

An additive manufacturing system includes at least two high power lasers to generate beams. A phase patterning unit is used to receive and alter phase of a beam from at least one of the two high power lasers. At least one phase patterned beam can be mixed with another beam at a print the print bed. In some embodiments, beams are moved with respect to the print bed by changes in phase patterns from the phase patterning unit. In other embodiments, phase patterns from the phase patterning unit can be used for simultaneous printing of multiple layers.

### RELATED APPLICATION

The present disclosure is part of a non-provisional patent application claiming the priority benefit of U.S. Patent Application No. 63/148,788, filed on Feb. 12, 2021, which is incorporated by reference in its entirety.

### TECHNICAL FIELD

The present disclosure generally relates to additive manufacturing systems that include holographic or phase based powder bed printing. More particularly, use of holographic techniques for application of high fluence beams is described.

### BACKGROUND

High power laser systems with light able to operate at high fluence for long durations are useful for additive manufacturing and other applications that can benefit from use of patterned high energy lasers. While some systems allow for printing of images, certain applications can benefit from holographic or phase-based beam steering and printing.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1A illustrates a phase patterning system for use in an additive manufacturing system;

FIG. 1B illustrates a phase patterning additive manufacturing system for direct bed write;

FIG. 1C illustrates a phase patterning additive manufacturing system that supports simultaneous multiple layer printing;

FIG. 1D illustrates a phase patterning additive manufacturing system that supports beam movement;

FIG. 1E illustrates a phased array lambda magic mirror control structure;

FIG. 1F illustrates a holographic light valve structure;

FIG. 1G illustrates a holographic light valve structure with reformatted patterns defined at an image plane on a print bed.

FIG. 2 illustrates a block diagram of a high fluence light valve based additive manufacturing system supporting a beam dump, a phase or image patterning system, and a heat engine;

FIG. 3 illustrates a high fluence additive manufacturing system;

FIG. 4 illustrates another embodiment of a high fluence additive manufacturing system; and

FIG. 5 illustrates another embodiment of a high fluence additive manufacturing which incorporates a switchyard approach for recovery and further usage of waste energy.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

In the following disclosure, an additive manufacturing system can include at least two high power, mutually coherent lasers to generate beams. A phase patterning unit is used to receive and alter phase of a beam from at least one of the two high power lasers. At least one phase patterned beam can be mixed with another beam at a print the print bed. In some embodiments, beams are moved with respect to the print bed by changes in phase patterns from the phase patterning unit. In other embodiments, phase patterns from the phase patterning unit can be used for simultaneous printing of multiple layers.

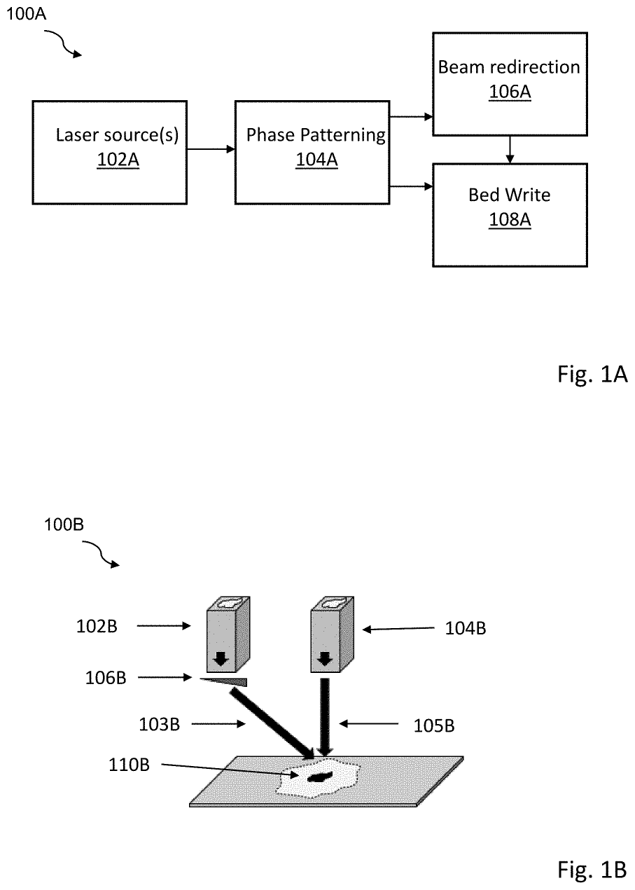

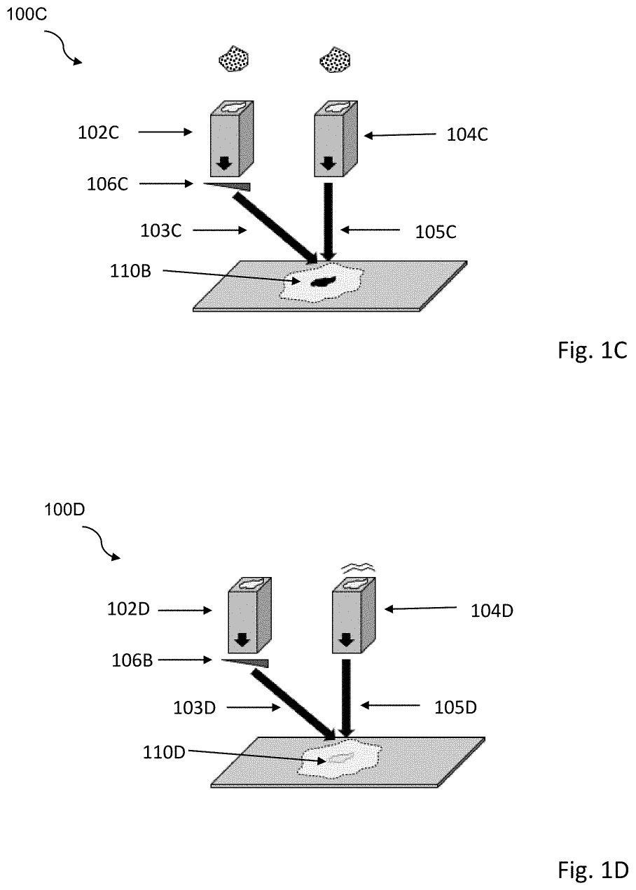

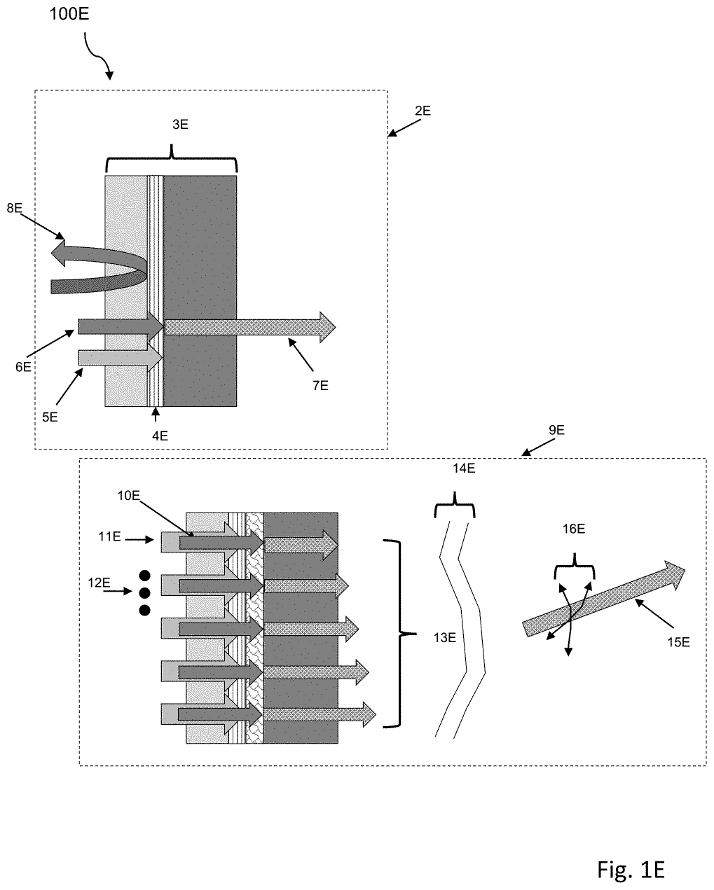

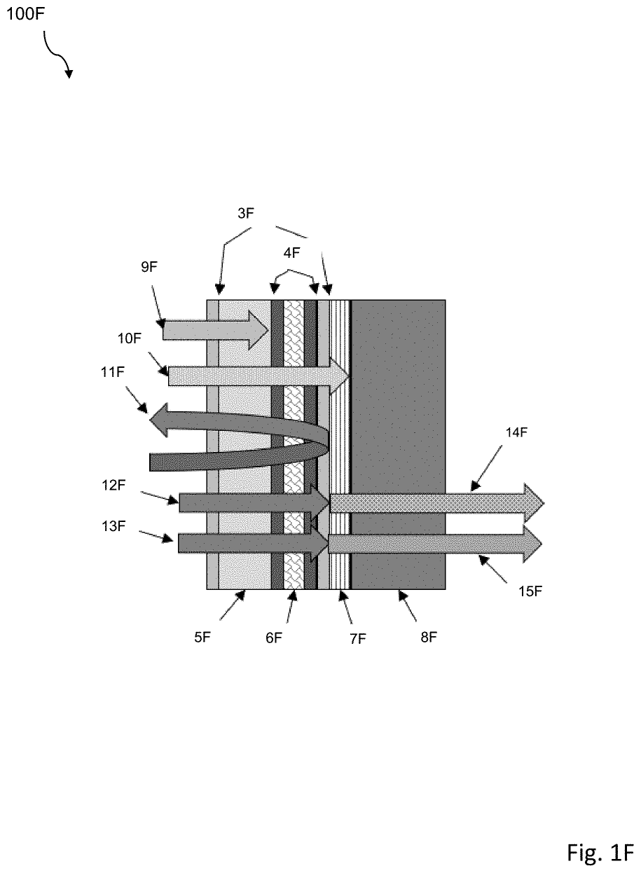

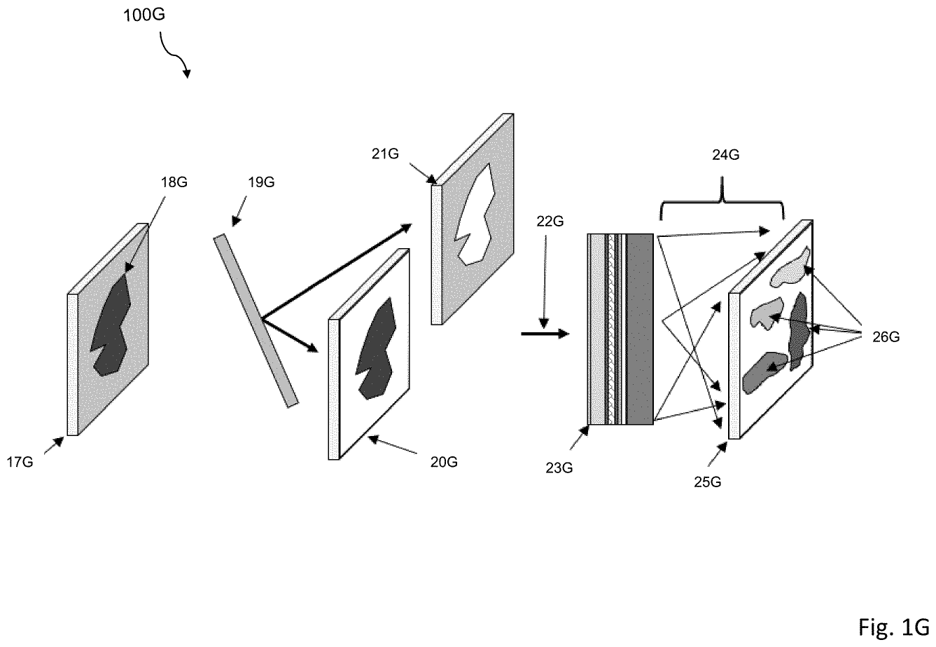

FIG. 1A illustrates a phase patterning system for use in an additive manufacturing system includes a laser source 102A and a phase patterning unit 104A. The phase patterning unit 104A can be used for beam redirection or movement 106A, direct bed write 108A, or both redirection or direct bed write for an additive manufacturing system. In operation, the phase patterning system can be based at least in part on a light valve system, with phase patterning by the light valve system or additional phase modification or delay units.

FIG. 1B illustrates portions of a phase patterning additive manufacturing system 100B for direct bed write. As shown, two mutually coherent laser units 102B and 104B respectively direct beams 103B and 105B toward an additive manufacturing print bed. In one embodiment, a controlled phase delay or patterning is introduced by phase delay or patterning unit 106B. The merged beams 103B and 105B are directly mixed at the bed to provide printed patterns 110B. In some embodiments, no patterns are associated with a pattern, and printed pattern 110B depends on number and respective angles of the mixed beams. For those embodiments in which each beam is patterned, a mix can represent a convolution of patterns (a mixing function). Typically, an embedded pattern on the LV is the Fourier transform of a desired image on the print bed surface.

In other embodiments, the number of combining beams at the print bed is larger than two with each additional beam resulting in better control as to desired pattern spacing, orientation with respect to powder spreading, tiling effects, or pattern apodizing.

In still other embodiments, a single beam is phase patterned and is split into a multitude of different paths and can overlap at the bed using integral imaging methods such as a lenslet array, or a plenoptic system. In this embodiment, each beamlet is automatically coherent with each other and may contain a portion of one phase pixel to multiple phase pixels. The interaction on the print bed generates a desired amplitude image that is used to print one or more planes of the desired object. An embodiment on this method allows for additional image wise modification prior to beamlet creation for better patterning such as tile melding or pattern orientation.

In another embodiment, two or more initially mutually incoherent lasers can be used in which one or all are slaved to a reference laser, which can be any one of these lasers or another more stable laser. This embodiment can include use of a mutually coherent laser.

FIG. 1C illustrates a phase patterning additive manufacturing system 100C that supports simultaneous multiple layer printing. As shown, two mutually coherent laser units 102C and 104C are arranged to direct multilayer point cloud patterns by direct beams 103C and 105C toward an additive manufacturing print bed. In one embodiment, a controlled phase delay or patterning is introduced by phase delay or patterning unit 106B. The merged beams 103B and 105B are directly mixed at the bed to provide printed patterns 110B. In some embodiments, two, three, or more layers can be simultaneously printed.

FIG. 1D illustrates a phase patterning additive manufacturing system 100D that supports beam movement. As shown, two mutually coherent laser units 102B and 104B respectively direct beams 103B and 105B toward an additive manufacturing print bed. In one embodiment, a controlled phase delay or patterning is introduced by phase delay or patterning unit 106B. The merged beams 103B and 105B are directly mixed at the bed to provide printed patterns 110B. Changing the phase delay of the beams 103B and 105B can result in moving pattern direction depending on number of beams and their angle. This can aid in accurate tile fusing. In some embodiments, a larger number of layers can be printed with one beam while other beam(s) are used to present voxel information.

In one embodiment of the system 100D an area phase delay occurs on one beam so that a slice of the potential point cloud in other beams during mixing is printed while in other embodiments discrete voxels are printed. An additional embodiment is where the either the areal delay or voxel delay is dynamically varied over the print timeframe so that better layer fusing is performed.

Yet another embodiment of this approach is to allow gray scale modifications between layers and thus extend the areal benefits of gray scale printing into the third dimension.

FIG. 1E illustrates a phased array lambda magic mirror control structure 100E with a LMM structured to be a phased array for high fluence beam non-mechanical beam steering. In a first embodiment 2E the LMM is used as a phased array for beam steering. In a second embodiment the LMM includes a phased delay layer 4E. A gray scale patterned write beam 5E at wavelength λ1 enters the LMM phased array structure and affects the refractive index of the control layer within the resonator. An unpatterned high fluence and high coherence beam 6E at wavelength λ2 also enters the LMM and interacts with the resonator being controlled by the write beam. Where the write beam is activated and affecting the control structure, the high fluence beam undergoes phase delay across the affected area of the LMM and undergoes patterned phase delay across the LMM. The coherent phasing imparted by the resonator (dictated by the gray scale patterning of the write beam) allows the outgoing high fluence beam 7E to be steered with respect to one when the write beam contains no gray scale quality nor when the high fluence beam has high coherency. In the areas where the write beam is not activated or where the high fluence beam's coherency has been reduced (up-steam control of its coherency), the LMM acts as reflector for the high fluence beam and its energy is reflected away 8E. While this depiction of the phased array LMM is shown in transmission when activated, the converse can also be designed.

Embodiment 9E shows in detail of the phasing of the LMM embodiment 2E. A typical high fluence and high coherency beam 10E arrives at same location as that of the write beam 11E. Likewise, across the LMM, a plethora 12E of paired high fluence and write beams enter the phased array LMM. The write beams are patterned and have gray scale intensity levels while the high fluence beams has equally high coherency and have a null phase relationship with each other. The write beams interact with the control structure and impart varying modification to the control structure's refractive index dependent on the intensity level of each write beam. The high fluence beam interacts with the resonator and each beam acquires a certain amount of phase retardation or advancement depending on the write beam intensity. Upon leaving the LMM phased array, the ensemble of high fluence beams 13E now have a phase relationship with each other. After an amount of propagation 14E, usually 5-10× the clear aperture of the ensemble), the phased response becomes evident and the high fluence beam attains a directionality 15E that is the phasor addition of the exiting ensemble. By modifying the spatially and gray scale pattern of the write beam, the beam can be non-mechanically steered across a range of angles 16E dictated by the maximum refractive index change of the control media by the write beam and the resonator's quality function. The high fluence output from this type of phased array contains no gray scale on its intensity.

FIG. 1F illustrates a Holographic LV (HLV) system 100F. As compared to the embodiment discussed with respect to FIG. 1E, the described HLV contains an additional control structure that allows gray scale modification and imparting direction phase to the high fluence. An exemplary HLV (2F) is composed of several layers and structures. Transparent Conductive Oxide (TCO, 3F) layers allow the structure to be field activated (in this example, electrically). Impedance matching layers (4F) allow for an EO layer (6F) to be used to impart phase to the high fluence beam. A photoconductor (PC) structure (5F) responds to the gray scale patterned PC write beam at λ1 (9F) by transferring a field (in this case, electrical) from the outside TCO (3F) to across the EO layer (6F) and imparting a gray scale phase image to the LC that matches the gray scale patterned PC write beam interacting with the PC. The LC layer imparts a gray scale phase information onto an unpatterned high fluence beam (13F) at λ3, creating a phase pattern imbued high fluence beam (12F).

An LMM layer (7F) responds to a gray scale patterned LMM write beam (10F) at λ2. The modified LMM layer imparts a gray scale amplitude image onto an already phase modified high fluence (12F) beam to create an amplitude and phase high fluence beam (14F). The control write beams (9F and 10F) are both gray scale and can allow for the high fluence beam to have gray scale phase and gray scale amplitude or gray scale amplitude with no phase. When the EO and LMM layers are not activated by their control write beams, the high fluence beam is rejected (11F) and that portion of the resulting high fluence passage through the HLV is off (dark).

Additional examples of HLV applications include use of a full holographic field generator where an unpatterned high fluence beam has a holographic field imposed onto it for a large variety of applications which include are but not limited to:

Gray scale holographic printing by coherently recombining the beamlets on the print bed;

Producing a holographic point cloud which would allow volumetric printing in a phase-managed additive manufacturing system;

Selectively printing slices of the point cloud by adjusting the phasing of certain beamlets to be in or out of phase with other portions the point cloud in a volumetric printing application. By adjusting the motion both lateral (x and y) and in z axis (depth) using dynamic gray scale on the phase write beam, which would translate to linear motion when these beamlets interact with static gray scale on other portions of the phase write beam. This would allow for better tile and layer fusing not provided by any other additive manufacturing method;

Use as a gray scale optical phased array with one or multiple independent output beams. Either one or multiple beams can be independently be adjusted in 2D angle and amplitude. The high fluence beam can be constructed to be composed of a complex temporal response so that time of flight information could be retrieved from the above HLV phased array using either single or multiple beam scenarios independent of the scan angle of the beam(s);

Use as a holographic tractor beam or beamlets to hold, manipulate and move particles in space. The heavier or denser the particle requires a higher fluence beam in the manipulating tractor beam. The applicability of this application for high fluence beams would be to manipulate metal/ceramic/allow powders in likewise AM printing applications. The manipulation and control of heavy/dense powders could be used for powder spreading or elimination of powder spreading entirely by applying powder only where it is needed in the print volume;

Use of a holographic field generator in an adaptive optic system in analyzing a volume of powder on a print bed using a high fluence beam below the threshold to melt the powder. The analysis of the resulting scatter field is then used to modify the holographic field so that a 3D melt pattern can be generated to melt a volume of powder in the desired 3D shape for that volume. Both the analysis and melt can be performed with the HLV by tailoring the intensity of the holographic field with the control write beam controlling the LMM layer.

FIG. 1G illustrates an example of how a holographic light valve system 100G can be utilized in a metal AM printing application as a reformatting LV in which rejected light is reformatted into useful print patterns in a one step. The reformatting process starts with a high fluence beam (17G) containing a polarized image (18G). The amplitude image is produced when this pattern passes through a polarizer (19G) creating high fluence amplitude image (20) which is transferred to the print bed and a rejection image (21G) containing the light rejected by the polarizer. This rejection image goes into the HLV (23G) to be re-formatted along path (22G). Not shown in (23G) are the control write beams for clarity. The control write beams impose phase and amplitude patterns onto the EO and LMM layers producing a complex holographic field representation of the resulting desired patterns, this information is imposed onto the rejected pattern incident on the HLV with the result of beamlets emerging from the HLV that organize themselves (via coherent phasing) over a propagation distance (24G) at an image relay plane (25G) into the desired reformatted image (26G). The reformatted image plane is then imaged onto the print bed using an image relay system as is normal for its printing systems. The propagation distance can be shortened by using a standard 4F Fourier Transform system (not shown) for aid in system packaging. In some embodiments, the image relay plane can be the print bed.

A wide range of lasers of various wavelengths can used in combination with the described phase control systems. In some embodiments, possible laser types include, but are not limited to: Gas Lasers, Chemical Lasers, Dye Lasers, Metal Vapor Lasers, Solid State Lasers (e.g. fiber), Semiconductor (e.g. diode) Lasers, Free electron laser, Gas dynamic laser, “Nickel-like” Samarium laser, Raman laser, or Nuclear pumped laser.

A Gas Laser can include lasers such as a Helium-neon laser, Argon laser, Krypton laser, Xenon ion laser, Nitrogen laser, Carbon dioxide laser, Carbon monoxide laser or Excimer laser.

A Chemical laser can include lasers such as a Hydrogen fluoride laser, Deuterium fluoride laser, COIL (Chemical oxygen-iodine laser), or Agil (All gas-phase iodine laser).

A Metal Vapor Laser can include lasers such as a Helium-cadmium (HeCd) metal-vapor laser, Helium-mercury (HeHg) metal-vapor laser, Helium-selenium (HeSe) metal-vapor laser, Helium-silver (HeAg) metal-vapor laser, Strontium Vapor Laser, Neon-copper (NeCu) metal-vapor laser, Copper vapor laser, Gold vapor laser, or Manganese (Mn/MnCl₂) vapor laser. Rubidium or other alkali metal vapor lasers can also be used. A Solid State Laser can include lasers such as a Ruby laser, Nd:YAG laser, NdCrYAG laser, Er:YAG laser, Neodymium YLF (Nd:YLF) solid-state laser, Neodymium doped Yttrium orthovanadate(Nd:YVO₄) laser, Neodymium doped yttrium calcium oxoborateNd:YCa₄O(BO₃)³ or simply Nd:YCOB, Neodymium glass(Nd:Glass) laser, Titanium sapphire(Ti:sapphire) laser, Thulium YAG (Tm:YAG) laser, Ytterbium YAG (Yb:YAG) laser, Ytterbium:2O₃ (glass or ceramics) laser, Ytterbium doped glass laser (rod, plate/chip, and fiber), Holmium YAG (Ho:YAG) laser, Chromium ZnSe (Cr:ZnSe) laser, Cerium doped lithium strontium (or calcium)aluminum fluoride(Ce:LiSAF, Ce:LiCAF), Promethium 147 doped phosphate glass (147Pm⁺³:Glass) solid-state laser, Chromium doped chrysoberyl (alexandrite) laser, Erbium doped anderbium-ytterbium co-doped glass lasers, Trivalent uranium doped calcium fluoride (U:CaF₂) solid-state laser, Divalent samarium doped calcium fluoride(Sm:CaF₂) laser, or F-Center laser.

A Semiconductor Laser can include laser medium types such as GaN, InGaN, AlGaInP, AlGaAs, InGaAsP, GaInP, InGaAs, InGaAsO, GaInAsSb, lead salt, Vertical cavity surface emitting laser (VCSEL), Quantum cascade laser, Hybrid silicon laser, or combinations thereof.

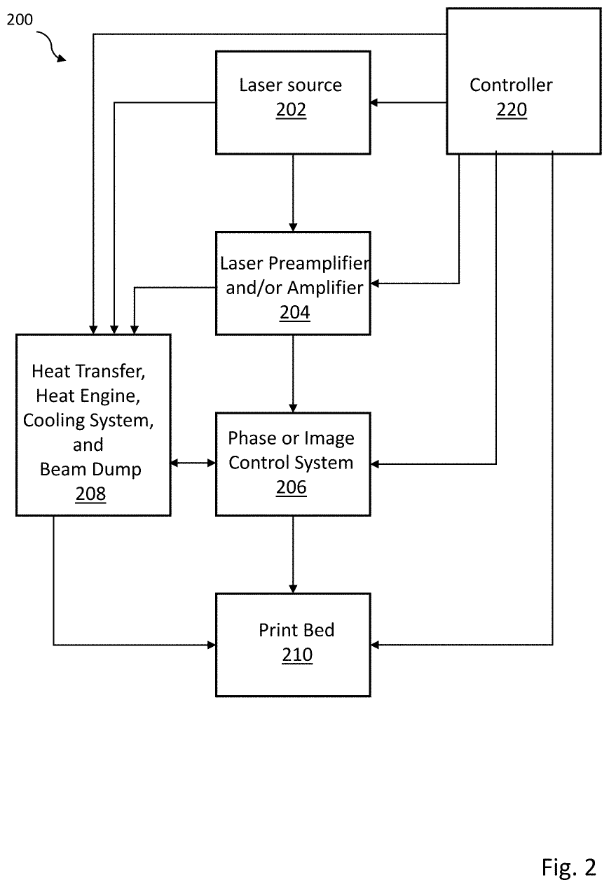

FIG. 2 illustrates use of a phase control or holographic system, with or without light valves, such as disclosed herein in an additive manufacturing system 200. In one embodiment, a laser source 202 directs a laser beam through a laser preamplifier and/or amplifier 204 into a phase control system 206 that can optionally include a light valve. After phase patterning, light can be directed into a print bed 210. In some embodiments, heat or laser energy from laser source 202, laser preamplifier and/or amplifier 204, or phase control system 206 can be actively or passively transferred to a heat transfer, heat engine, cooling system, and beam dump 208. Overall operation of the light valve based additive manufacturing system 200 can controlled by one or more controllers 220 that can modify laser power and timing.

In some embodiments, various preamplifiers or amplifiers 204 are optionally used to provide high gain to the laser signal, while optical modulators and isolators can be distributed throughout the system to reduce or avoid optical damage, improve signal contrast, and prevent damage to lower energy portions of the system 200. Optical modulators and isolators can include, but are not limited to Pockels cells, Faraday rotators, Faraday isolators, acousto-optic reflectors, or volume Bragg gratings. Pre-amplifier or amplifiers 204 could be diode pumped or flash lamp pumped amplifiers and configured in single and/or multi-pass or cavity type architectures. As will be appreciated, the term pre-amplifier here is used to designate amplifiers which are not limited thermally (i.e. they are smaller) versus laser amplifiers (larger). Amplifiers will typically be positioned to be the final units in a laser system 200 and will be the first modules susceptible to thermal damage, including but not limited to thermal fracture or excessive thermal lensing.

Laser pre-amplifiers can include single pass pre-amplifiers usable in systems not overly concerned with energy efficiency. For more energy efficient systems, multi-pass pre-amplifiers can be configured to extract much of the energy from each pre-amplifier 204 before going to the next stage. The number of pre-amplifiers 204 needed for a particular system is defined by system requirements and the stored energy/gain available in each amplifier module. Multi-pass pre-amplification can be accomplished through angular multiplexing or polarization switching (e.g. using waveplates or Faraday rotators).

Alternatively, pre-amplifiers can include cavity structures with a regenerative amplifier type configuration. While such cavity structures can limit the maximum pulse length due to typical mechanical considerations (length of cavity), in some embodiments “White cell” cavities can be used. A “White cell” is a multi-pass cavity architecture in which a small angular deviation is added to each pass. By providing an entrance and exit pathway, such a cavity can be designed to have extremely large number of passes between entrance and exit allowing for large gain and efficient use of the amplifier. One example of a White cell would be a confocal cavity with beams injected slightly off axis and mirrors tilted such that the reflections create a ring pattern on the mirror after many passes. By adjusting the injection and mirror angles the number of passes can be changed.

Amplifiers are also used to provide enough stored energy to meet system energy requirements, while supporting sufficient thermal management to enable operation at system required repetition rate whether they are diode or flashlamp pumped. Both thermal energy and laser energy generated during operation can be directed the heat transfer, heat engine, cooling system, and beam dump 208.

Amplifiers can be configured in single and/or multi-pass or cavity type architectures. Amplifiers can include single pass amplifiers usable in systems not overly concerned with energy efficiency. For more energy efficient systems, multi-pass amplifiers can be configured to extract much of the energy from each amplifier before going to the next stage. The number of amplifiers needed for a particular system is defined by system requirements and the stored energy/gain available in each amplifier module. Multipass pre-amplification can be accomplished through angular multiplexing, polarization switching (waveplates, Faraday rotators). Alternatively, amplifiers can include cavity structures with a regenerative amplifier type configuration. As discussed with respect to pre-amplifiers, amplifiers can be used for power amplification.

In some embodiments, thermal energy and laser energy generated during operation of system 200 can be directed into the heat transfer, heat engine, cooling system, and beam dump 208. Alternatively, or in addition, in some embodiments the beam dump 208 can be a part of a heat transfer system to provide useful heat to other industrial processes. In still other embodiments, the heat can be used to power a heat engine suitable for generating mechanical, thermoelectric, or electric power. In some embodiments, waste heat can be used to increase temperature of connected components. As will be appreciated, laser flux and energy can be scaled in this architecture by adding more pre-amplifiers and amplifiers with appropriate thermal management and optical isolation. Adjustments to heat removal characteristics of the cooling system are possible, with increase in pump rate or changing cooling efficiency being used to adjust performance.

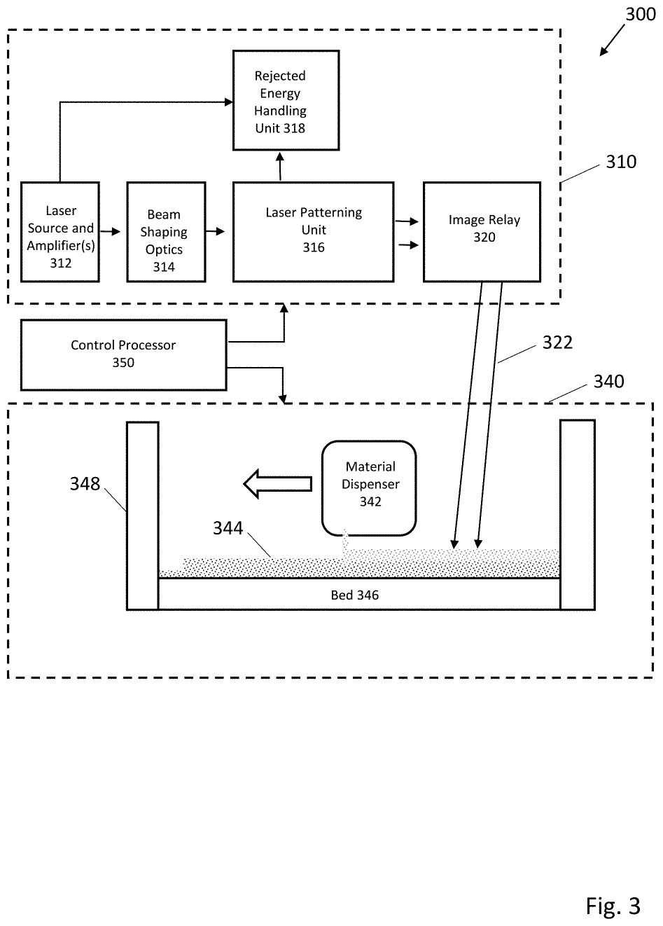

FIG. 3 illustrates an additive manufacturing system 300 that can accommodate phase control systems as described in this disclosure. As seen in FIG. 3, a laser source and amplifier(s) 312 can include phase control systems, light valves, and laser amplifiers and other components such as previously described. As illustrated in FIG. 3, the additive manufacturing system 300 uses lasers able to provide one or two dimensional directed energy as part of a laser patterning system 310. In some embodiments, phase patterns or holographic images can be directed. In other embodiments, one dimensional patterning can be directed as linear or curved strips, as rastered lines, as spiral lines, or in any other suitable form. Two or three-dimensional phase or image patterning embodiments are also possible, with use of separated or overlapping tiles, or images with variations in laser intensity. Two or three-dimensional phase or image patterns having non-square boundaries can be used, overlapping or interpenetrating images can be used, and images can be provided by two or more energy patterning systems. The laser patterning system 310 uses laser source and amplifier(s) 312 to direct one or more continuous or intermittent energy beam(s) toward beam shaping optics 314. After shaping, if necessary, the beam is patterned by a laser patterning unit 316 that can include either a transmissive or reflective light valve, with generally some energy being directed to a rejected energy handling unit 318. The rejected energy handling unit can utilize heat provided by active of cooling of light valves.

Phase or image patterned energy is relayed by image relay 320 toward an article processing unit 340, in one embodiment as a two-dimensional image 322 focused near a bed 346. The bed 346 (with optional walls 348) can form a chamber containing material 344 (e.g. a metal powder) dispensed by material dispenser 342. Patterned energy, directed by the image relay 320, can melt, fuse, sinter, amalgamate, change crystal structure, influence stress patterns, or otherwise chemically or physically modify the dispensed material 344 to form structures with desired properties. A control processor 350 can be connected to variety of sensors, actuators, heating or cooling systems, monitors, and controllers to coordinate operation of the laser source and amplifier(s) 312, beam shaping optics 314, laser patterning unit 316, and image relay 320, as well as any other component of system 300. As will be appreciated, connections can be wired or wireless, continuous or intermittent, and include capability for feedback (for example, thermal heating can be adjusted in response to sensed temperature).

In some embodiments, beam shaping optics 314 can include a great variety of imaging optics to combine, focus, diverge, reflect, refract, homogenize, adjust intensity, adjust frequency, or otherwise shape and direct one or more laser beams received from the laser source and amplifier(s) 312 toward the laser patterning unit 316. In one embodiment, multiple light beams, each having a distinct light wavelength, can be combined using wavelength selective mirrors (e.g. dichroics) or diffractive elements. In other embodiments, multiple beams can be homogenized or combined using multifaceted mirrors, microlenses, and refractive or diffractive optical elements.

Laser patterning unit 316 can include phase, image, static or dynamic energy patterning elements. For example, laser beams can be blocked by masks with fixed or movable elements. To increase flexibility and ease of image patterning, pixel addressable masking, image generation, or transmission can be used. In some embodiments, the laser patterning unit includes addressable light valves, alone or in conjunction with other patterning mechanisms to provide patterning. The light valves can be transmissive, reflective, or use a combination of transmissive and reflective elements. Phase or image patterns can be dynamically modified using electrical or optical addressing. In one embodiment, a transmissive optically addressed light valve acts to rotate polarization of light passing through the valve, with optically addressed pixels forming patterns defined by a light projection source. In another embodiment, a reflective optically addressed light valve includes a write beam for modifying polarization of a read beam. In certain embodiments, non-optically addressed light valves can be used. These can include but are not limited to electrically addressable pixel elements, movable mirror or micro-mirror systems, piezo or micro-actuated optical systems, fixed or movable masks, or shields, or any other conventional system able to provide high intensity light patterning.

Rejected energy handling unit 318 is used to disperse, redirect, or utilize energy not patterned and passed through the image relay 320. In one embodiment, the rejected energy handling unit 318 can include passive or active cooling elements that remove heat from both the laser source, light valve(s), and amplifier(s) 312 and the laser patterning unit 316. In other embodiments, the rejected energy handling unit can include a “beam dump” to absorb and convert to heat any beam energy not used in defining the laser pattern. In still other embodiments, rejected laser beam energy can be recycled using beam shaping optics 314. Alternatively, or in addition, rejected beam energy can be directed to the article processing unit 340 for heating or further patterning. In certain embodiments, rejected beam energy can be directed to additional energy patterning systems or article processing units.

In one embodiment, a “switchyard” style optical system can be used. Switchyard systems are suitable for reducing the light wasted in the additive manufacturing system as caused by rejection of unwanted light due to the pattern to be printed. A switchyard involves redirections of a complex pattern from its generation (in this case, a plane whereupon a spatial pattern is imparted to structured or unstructured beam) to its delivery through a series of switch points. Each switch point can optionally modify the spatial profile of the incident beam. The switchyard optical system may be utilized in, for example and not limited to, laser-based additive manufacturing techniques where a mask is applied to the light. Advantageously, in various embodiments in accordance with the present disclosure, the thrown-away energy may be recycled in either a homogenized form or as a patterned light that is used to maintain high power efficiency or high throughput rates. Moreover, the thrown-away energy can be recycled and reused to increase intensity to print more difficult materials.

Image relay 320 can receive a patterned image (either one or two-dimensional) from the laser patterning unit 316 directly or through a switchyard and guide it toward the article processing unit 340. In a manner similar to beam shaping optics 314, the image relay 320 can include optics to combine, focus, diverge, reflect, refract, adjust intensity, adjust frequency, or otherwise shape and direct the patterned light. Patterned light can be directed using movable mirrors, prisms, diffractive optical elements, or solid state optical systems that do not require substantial physical movement. One of a plurality of lens assemblies can be configured to provide the incident light having the magnification ratio, with the lens assemblies both a first set of optical lenses and a second sets of optical lenses, and with the second sets of optical lenses being swappable from the lens assemblies. Rotations of one or more sets of mirrors mounted on compensating gantries and a final mirror mounted on a build platform gantry can be used to direct the incident light from a precursor mirror onto a desired location. Translational movements of compensating gantries and the build platform gantry are also able to ensure that distance of the incident light from the precursor mirror the article processing unit 340 is substantially equivalent to the image distance. In effect, this enables a quick change in the optical beam delivery size and intensity across locations of a build area for different materials while ensuring high availability of the system.

Article processing unit 340 can include a walled chamber 348 and bed 344 (collectively defining a build chamber), and a material dispenser 342 for distributing material. The material dispenser 342 can distribute, remove, mix, provide gradations or changes in material type or particle size, or adjust layer thickness of material. The material can include metal, ceramic, glass, polymeric powders, other melt-able material capable of undergoing a thermally induced phase change from solid to liquid and back again, or combinations thereof. The material can further include composites of melt-able material and non-melt-able material where either or both components can be selectively targeted by the imaging relay system to melt the component that is melt-able, while either leaving along the non-melt-able material or causing it to undergo a vaporizing/destroying/combusting or otherwise destructive process. In certain embodiments, slurries, sprays, coatings, wires, strips, or sheets of materials can be used. Unwanted material can be removed for disposable or recycling by use of blowers, vacuum systems, sweeping, vibrating, shaking, tipping, or inversion of the bed 346.

In addition to material handling components, the article processing unit 340 can include components for holding and supporting 3D structures, mechanisms for heating or cooling the chamber, auxiliary or supporting optics, and sensors and control mechanisms for monitoring or adjusting material or environmental conditions. The article processing unit can, in whole or in part, support a vacuum or inert gas atmosphere to reduce unwanted chemical interactions as well as to mitigate the risks of fire or explosion (especially with reactive metals). In some embodiments, various pure or mixtures of other atmospheres can be used, including those containing Ar, He, Ne, Kr, Xe, CO2, N2, O2, SF6, CH4, CO, N2O, C2H2, C2H4, C2H6, C3H6, C3H8, i-C4H10, C4H10, 1-C4H8, cic-2, C4H7, 1,3-C4H6, 1,2-C4H6, C5H12, n-C5H12, i-C5H12, n-C6H14, C2H3Cl, C7H16, C8H18, C10H22, C11H24, C12H26, C13H28, C14H30, C15H32, C16H34, C6H6, C6H5-CH3, C8H10, C2H5OH, CH3OH, iC4H8. In some embodiments, refrigerants or large inert molecules (including but not limited to sulfur hexafluoride) can be used. An enclosure atmospheric composition to have at least about 1% He by volume (or number density), along with selected percentages of inert/non-reactive gasses can be used.

In certain embodiments, a plurality of article processing units or build chambers, each having a build platform to hold a powder bed, can be used in conjunction with multiple optical-mechanical assemblies arranged to receive and direct the one or more incident energy beams into the build chambers. Multiple chambers allow for concurrent printing of one or more print jobs inside one or more build chambers. In other embodiments, a removable chamber sidewall can simplify removal of printed objects from build chambers, allowing quick exchanges of powdered materials. The chamber can also be equipped with an adjustable process temperature controls. In still other embodiments, a build chamber can be configured as a removable printer cartridge positionable near laser optics. In some embodiments a removable printer cartridge can include powder or support detachable connections to a powder supply. After manufacture of an item, a removable printer cartridge can be removed and replaced with a fresh printer cartridge.

In another embodiment, one or more article processing units or build chambers can have a build chamber that is maintained at a fixed height, while optics are vertically movable. A distance between final optics of a lens assembly and a top surface of powder bed a may be managed to be essentially constant by indexing final optics upwards, by a distance equivalent to a thickness of a powder layer, while keeping the build platform at a fixed height. Advantageously, as compared to a vertically moving the build platform, large and heavy objects can be more easily manufactured, since precise micron scale movements of the ever changing mass of the build platform are not needed. Typically, build chambers intended for metal powders with a volume more than ˜0.1-0.2 cubic meters (i.e., greater than 100-200 liters or heavier than 500-1,000 kg) will most benefit from keeping the build platform at a fixed height.

In one embodiment, a portion of the layer of the powder bed may be selectively melted or fused to form one or more temporary walls out of the fused portion of the layer of the powder bed to contain another portion of the layer of the powder bed on the build platform. In selected embodiments, a fluid passageway can be formed in the one or more first walls to enable improved thermal management.

In some embodiments, the additive manufacturing system can include article processing units or build chambers with a build platform that supports a powder bed capable of tilting, inverting, and shaking to separate the powder bed substantially from the build platform in a hopper. The powdered material forming the powder bed may be collected in a hopper for reuse in later print jobs. The powder collecting process may be automated and vacuuming or gas jet systems also used to aid powder dislodgement and removal.

Some embodiments, the additive manufacturing system can be configured to easily handle parts longer than an available build chamber. A continuous (long) part can be sequentially advanced in a longitudinal direction from a first zone to a second zone. In the first zone, selected granules of a granular material can be amalgamated. In the second zone, unamalgamated granules of the granular material can be removed. The first portion of the continuous part can be advanced from the second zone to a third zone, while a last portion of the continuous part is formed within the first zone and the first portion is maintained in the same position in the lateral and transverse directions that the first portion occupied within the first zone and the second zone. In effect, additive manufacture and clean-up (e.g., separation and/or reclamation of unused or unamalgamated granular material) may be performed in parallel (i.e., at the same time) at different locations or zones on a part conveyor, with no need to stop for removal of granular material and/or parts.

In another embodiment, additive manufacturing capability can be improved by use of an enclosure restricting an exchange of gaseous matter between an interior of the enclosure and an exterior of the enclosure. An airlock provides an interface between the interior and the exterior; with the interior having multiple additive manufacturing chambers, including those supporting power bed fusion. A gas management system maintains gaseous oxygen within the interior at or below a limiting oxygen concentration, increasing flexibility in types of powder and processing that can be used in the system.

In another manufacturing embodiment, capability can be improved by having an article processing units or build chamber contained within an enclosure, the build chamber being able to create a part having a weight greater than or equal to 2,000 kilograms. A gas management system may maintain gaseous oxygen within the enclosure at concentrations below the atmospheric level. In some embodiments, a wheeled vehicle may transport the part from inside the enclosure, through an airlock, since the airlock operates to buffer between a gaseous environment within the enclosure and a gaseous environment outside the enclosure, and to a location exterior to both the enclosure and the airlock.

Other manufacturing embodiments involve collecting powder samples in real-time from the powder bed. An ingester system is used for in-process collection and characterizations of powder samples. The collection may be performed periodically and the results of characterizations result in adjustments to the powder bed fusion process. The ingester system can optionally be used for one or more of audit, process adjustments or actions such as modifying printer parameters or verifying proper use of licensed powder materials.

Yet another improvement to an additive manufacturing process can be provided by use of a manipulator device such as a crane, lifting gantry, robot arm, or similar that allows for the manipulation of parts that would be difficult or impossible for a human to move is described. The manipulator device can grasp various permanent or temporary additively manufactured manipulation points on a part to enable repositioning or maneuvering of the part.

Control processor 350 can be connected to control any components of additive manufacturing system 300 described herein, including lasers, laser amplifiers, optics, heat control, build chambers, and manipulator devices. The control processor 350 can be connected to variety of sensors, actuators, heating or cooling systems, monitors, and controllers to coordinate operation. A wide range of sensors, including imagers, light intensity monitors, thermal, pressure, or gas sensors can be used to provide information used in control or monitoring. The control processor can be a single central controller, or alternatively, can include one or more independent control systems. The controller processor 350 is provided with an interface to allow input of manufacturing instructions. Use of a wide range of sensors allows various feedback control mechanisms that improve quality, manufacturing throughput, and energy efficiency.

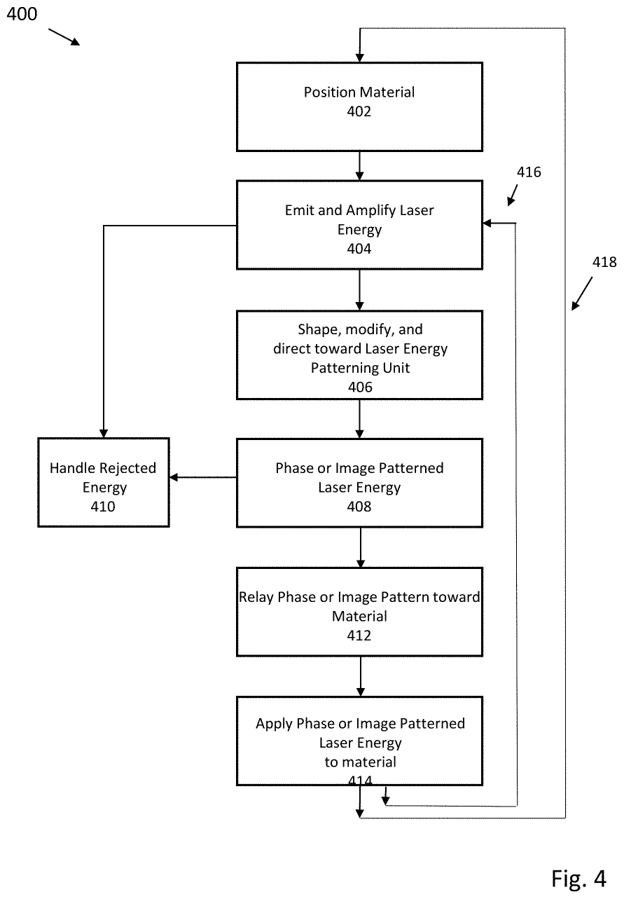

One embodiment of operation of a manufacturing system supporting use of a phase patterned laser energy suitable for additive or subtractive manufacture is illustrated in FIG. 4. In this embodiment, a flow chart 400 illustrates one embodiment of a manufacturing process supported by the described optical and mechanical components. In step 402, material is positioned in a bed, chamber, or other suitable support. The material can be a metal plate for laser cutting using subtractive manufacture techniques, or a powder capable of being melted, fused, sintered, induced to change crystal structure, have stress patterns influenced, or otherwise chemically or physically modified by additive manufacturing techniques to form structures with desired properties.

In step 404, unpatterned laser energy is emitted by one or more energy emitters, including but not limited to solid state or semiconductor lasers, and then amplified by one or more laser amplifiers. In step 406, the unpatterned laser energy is shaped and modified (e.g. intensity modulated or focused). In step 408, this unpatterned laser energy is patterned by a phase patterning unit, which can include optional use of a light valve, with energy not forming a part of the phase or image pattern being handled in step 410 (this can include use of a beam dump as disclosed with respect to FIG. 2 and FIG. 3 that provide conversion to waste heat, recycling as patterned or unpatterned energy, or waste heat generated by cooling the laser amplifiers in step 404). In step 412, the patterned energy, now forming a one or two-dimensional image is relayed toward the material. In step 414, the image is applied to the material, either subtractively processing or additively building a portion of a 3D structure. For additive manufacturing, these steps can be repeated (loop 416) until the image (or different and subsequent image) has been applied to all necessary regions of a top layer of the material. When application of energy to the top layer of the material is finished, a new layer can be applied (loop 418) to continue building the 3D structure. These process loops are continued until the 3D structure is complete, when remaining excess material can be removed or recycled.

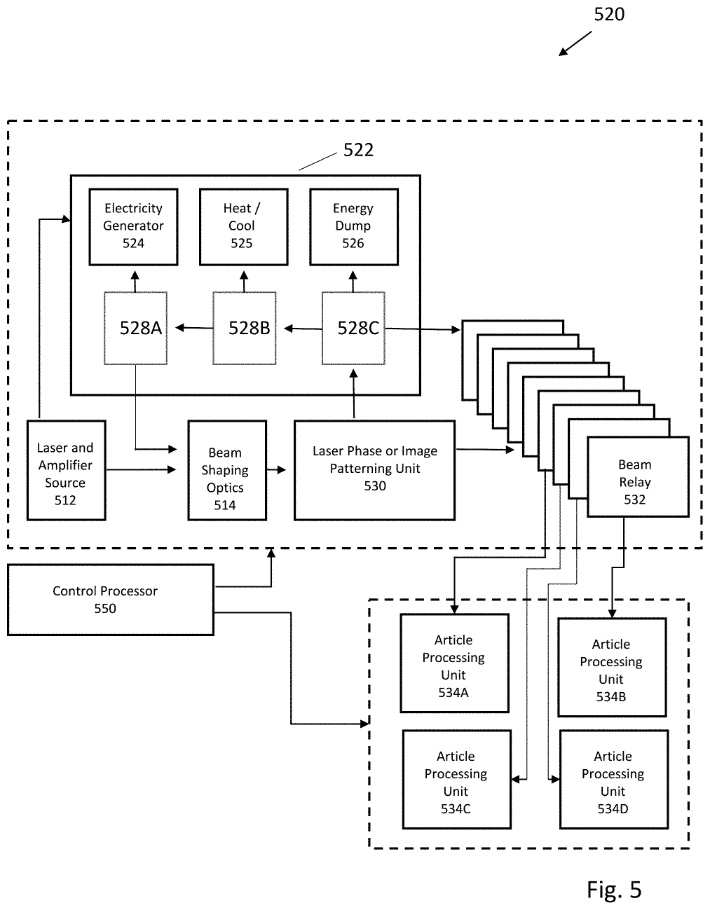

FIG. 5 is one embodiment of an additive manufacturing system that includes a phase and/or image patterning unit and a switchyard system enabling reuse of phase or image patterned two-dimensional energy. An additive manufacturing system 520 has an energy patterning system with a laser and amplifier source 512 that directs one or more continuous or intermittent laser beam(s) toward beam shaping optics 514. Excess heat can be transferred into a rejected energy handling unit 522 that can include an active light valve cooling system as disclosed with respect to FIGS. 1A-1D, FIG. 2, FIG. 3, and FIG. 4. After shaping, the beam is two-dimensionally patterned by a laser phase patterning unit 530, with generally some energy being directed to the rejected energy handling unit 522. Patterned energy is relayed by one of multiple image relays 532 toward one or more article processing units 534A, 534B, 534C, or 534D, typically as a two-dimensional image focused near a movable or fixed height bed. The bed can be inside a cartridge that includes a powder hopper or similar material dispenser. Patterned laser beams, directed by the image relays 532, can melt, fuse, sinter, amalgamate, change crystal structure, influence stress patterns, or otherwise chemically or physically modify the dispensed material to form structures with desired properties.

In this embodiment, the rejected energy handling unit has multiple components to permit reuse of rejected patterned energy. Coolant fluid from the laser amplifier and source 512 can be directed into one or more of an electricity generator 524, a heat/cool thermal management system 525, or an energy dump 526. Additionally, relays 528A, 528B, and 528C can respectively transfer energy to the electricity generator 524, the heat/cool thermal management system 525, or the energy dump 526. Optionally, relay 528C can direct patterned energy into the image relay 532 for further processing. In other embodiments, patterned energy can be directed by relay 528C, to relay 528B and 528A for insertion into the laser beam(s) provided by laser and amplifier source 512. Reuse of patterned images is also possible using image relay 532. Images can be redirected, inverted, mirrored, sub-patterned, or otherwise transformed for distribution to one or more article processing units. 534A-D. Advantageously, reuse of the patterned light can improve energy efficiency of the additive manufacturing process, and in some cases improve energy intensity directed at a bed or reduce manufacture time.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. An additive manufacturing system, comprising:
at least two high power lasers to generate beams;
a phase patterning unit to receive and alter phase of a beam from at least one of the two high power lasers; and
wherein mixing of at least one phase patterned beam with another beam occurs at a print bed.

2. The additive manufacturing system of claim 1, wherein the two high power lasers are mutually coherent.

3. The additive manufacturing system of claim 1, wherein more than two lasers are used to generate beams.

4. The additive manufacturing system of claim 1, wherein phase alteration occurs over the entire beam of each laser.

5. The additive manufacturing system of claim 1, wherein phase alteration occurs as a pixelated image impressed on to each beam.

6. The additive manufacturing system of claim 1, wherein phase alteration occurs on each beam by adjusting the angle at which it overlaps with other beams at the print bed, producing patterns related to number and set of angles made with the other beams at the print bed.

7. The additive manufacturing system of claim 1, wherein the two high power lasers are coupled to each other through a master oscillator optical amplifier (MOPA) optical circuit to enhance mutual coherency.

8. The additive manufacturing system of claim 1, wherein phase patterning on each beam is broken into a multitude of separate beams, conveyed to the bed using lenslet or plenoptic imaging at which point the array of beamlets coherently mix to form a desired pattern on the print bed.

9. The additive manufacturing system of claim 1, wherein beams are holographically patterned with complex volumetric phase information.

10. The additive manufacturing system of claim 9, wherein holographically patterned beams coherently mix at the print bed to allow two or more layers to be simultaneously printed.

11. The additive manufacturing system of claim 9, wherein one or more beams contain areal phase delay to coherently mix at the print bed with the other holographically patterned beams and allow selected layer or layers to be printed.

12. The additive manufacturing system of claim 9, wherein one or more beams contain pixel wise phase delay to allow coherent mixing at the print bed, with selected voxels being printed.

14. The additive manufacturing system of claim 9, wherein the areal phase delay is varied over a print timeframe to allow dynamic blurring and tile-to-tile fusing.

15. The additive manufacturing system of claim 10, wherein pixel-wise phase delay is varied over the time for volume printing to allow dynamic voxel blurring for better layer-to-layer fusing.

16. The additive manufacturing system of claim 10, wherein beams are configured to allow gray scale patterning between layers.

17. The additive manufacturing system of claim 1, wherein beams are moved with respect to the print bed by changes in phase patterns from the phase patterning unit.

18. The additive manufacturing system of claim 1, wherein the phase patterns from the phase patterning unit result in simultaneous printing of multiple layers.

19. An additive manufacturing system that recycles laser power, comprising:
at least two high power lasers to generate beams, with at least some beams being partially mixed;
a phase patterning unit to receive and alter phase of a beam from at least one of the two high power lasers; and
wherein mixing of at least one phase patterned beam with another beam occurs at a print bed and at least some unmixed beams are recycled to provide further beam patterning.

20. An additive manufacturing switchyard system that redirects laser power, comprising:
at least two high power lasers to generate two-dimensional image forming beams, with at least some two-dimensional image forming beams being redirected by the switchyard system for reuse or phase mixing;
a phase patterning unit to receive and alter phase of a two-dimensional image forming beam from at least one of the two high power lasers; and
wherein mixing of at least one phase patterned beam with another beam occurs at a print bed.

21. An additive manufacturing method, comprising:
generating beams using at least two high power lasers;
positioning a phase patterning unit to receive and alter phase of a beam from at least one of the two high power lasers; and
mixing at least one phase patterned beam with another beam at a print bed.

22. The additive manufacturing method of claim 21, wherein the two high power lasers are mutually coherent.

23. The additive manufacturing method of claim 21, wherein more than two lasers are used to generate beams.

24. The additive manufacturing method of claim 21, wherein phase alteration occurs over the entire beam of each laser.

25. The additive manufacturing method of claim 21, wherein phase alteration occurs as a pixelated image impressed on to each beam.

26. The additive manufacturing method of claim 21, wherein phase alteration occurs on each beam by adjusting the angle at which it overlaps with other beams at the print bed, producing patterns related to number and set of angles made with the other beams at the print bed.

27. The additive manufacturing method of claim 21, wherein the two high power lasers are coupled to each other through a master oscillator optical amplifier (MOPA) optical circuit to enhance mutual coherency.

28. The additive manufacturing method of claim 21, wherein phase patterning on each beam is broken into a multitude of separate beams, conveyed to the bed using lenslet or plenoptic imaging at which point the array of beamlets coherently mix to form a desired pattern on the print bed.

29. The additive manufacturing method of claim 21, wherein beams are holographically patterned with complex volumetric phase information.

30. The additive manufacturing method of claim 29, wherein holographically patterned beams coherently mix at the print bed to allow two or more layers to be simultaneously printed.

31. The additive manufacturing method of claim 29, wherein one or more beams contain areal phase delay to coherently mix at the print bed with the other holographically patterned beams and allow selected layer or layers to be printed.

32. The additive manufacturing method of claim 29, wherein one or more beams contain pixel wise phase delay to allow coherent mixing at the print bed, with selected voxels being printed.

34. The additive manufacturing method of claim 29, wherein the areal phase delay is varied over a print timeframe to allow dynamic blurring and tile-to-tile fusing.

35. The additive manufacturing method of claim 30, wherein pixel-wise phase delay is varied over the time for volume printing to allow dynamic voxel blurring for better layer-to-layer fusing.

36. The additive manufacturing method of claim 30, wherein beams are configured to allow gray scale patterning between layers.

37. The additive manufacturing method of claim 21, wherein beams are moved with respect to the print bed by changes in phase patterns from the phase patterning unit.

38. The additive manufacturing method of claim 21, wherein the phase patterns from the phase patterning unit result in simultaneous printing of multiple layers.
